(19) United States
(12) Patent Application Publication
(10) Pub. No.: US 2024/0176000 A1
(43) Pub. Date: May 30, 2024

(54) OPTICAL ELEMENT DAMAGE DETECTION INCLUDING STRAIN GAUGE

(71) Applicant: Continental Autonomous Mobility US, LLC, Auburn Hills, MI (US)

(72) Inventors: Octavio Samano Cancino, Oxnard, CA (US); Goran Vuletici, Santa Barbara, CA (US); Jose Miguel Banuelos Carrillo, Ventura, CA (US)

(73) Assignee: Continental Autonomous Mobility US, LLC, Auburn Hills, MI (US)

(21) Appl. No.: 18/060,403

(22) Filed: Nov. 30, 2022

(51) Int. Cl. G01S 7/497; G01N 19/08

(52) U.S. Cl. CPC G01S 7/497; G01N 19/08

(57) ABSTRACT

A LiDAR sensor includes an optical element having a light-shaping region and a light emitter aimed at the optical element. The optical element directs light from the light emitter into a field of illumination. A light detector has a field of view overlapping the field of illumination. A strain gauge is on the optical element. A method of operating the LiDAR sensor includes repeatedly measuring strain measurements of the optical element, determining that one of the strain measurements indicates that the optical element is damaged, and disabling the light emitter in response to the subsequent one of the strain measurements.

### BACKGROUND

A non-scanning LiDAR (Light Detection And Ranging) sensor, e.g., a solid-state LADAR sensor includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LADAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The LiDAR sensor may be mounted on a vehicle to detect objects in the environment surrounding the vehicle and to detect distances of those objects for environmental mapping. The output of the LiDAR sensor may be used, for example, to autonomously or semi-autonomously control operation of the vehicle, e.g., propulsion, braking, steering, etc. Specifically, the LiDAR sensor may be a component of or in communication with an advanced driver-assistance system (ADAS) of the vehicle.

The LiDAR sensor may include one or more optical elements that shape and/or direct light. For example, an optical element may be or include a diffuser such as a diffractive diffuser, a refractive diffuser, etc. Specifically, the LiDAR sensor includes a light emitter aimed at the diffuser such that light travels from the light emitter, through the diffuser, and into a field of view that is external to the LiDAR sensor. The diffuser shapes and/or directs the light from the light emitter into the field of view.

### BRIEF DESCRIPTION OF THE DRAWINGS

FIG. 1 is a perspective view of a vehicle including a LiDAR sensor.

FIG. 2 is a perspective view of the LiDAR sensor.

FIG. 3 is a cut-away view of one example of the LiDAR sensor

FIG. 3A is a magnified view of a portion of FIG. 3.

FIG. 4 is a cut-away view of one example of the LiDAR sensor

FIG. 4A is a magnified view of a portion of FIG. 3.

FIG. 5 is a block diagram of the LiDAR sensor.

FIG. 6 is a perspective view of a light detector of the LiDAR assembly.

FIG. 6A is a magnified view of the light detector schematically showing an array of photodetectors.

FIG. 7 is a block diagram of the LiDAR sensor.

FIG. 8 is a perspective view of a strain gauge assembly including three strain gauges.

FIG. 9 is a block diagram of a method of operating the LiDAR sensor.

### DETAILED DESCRIPTION

With reference to the Figures, wherein like numerals indicate like parts throughout the several views, a LiDAR sensor 10 includes an optical element 34, 36 having a light-shaping region 12. A light emitter 14 is aimed at the optical element 34, 36. The optical element 34, 36 directs light from the light emitter 14 into a field of illumination. A light detector 16 has a field of view overlapping the field of illumination. A strain gauge 18 is on the optical element 34, 36.

The strain gauge 18 measures the strain of the optical element 34, 36 and the integrity of the optical element 34, 36 may be determined based on strain measurements taken by the strain gauge 18. For example, strain measurements may be repeatedly taken and the various strain measurements may be compared to each other for patterns that indicate that the optical element 34, 36 is intact or damaged. As an example, multiple strain measurements at the various times that measure the same or relatively similar strain on the optical element 34, 36 indicate that the optical element 34, 36 is intact. Similarly multiple strain measurements at various that show relatively gradual change in strain on the optical element 34, 36 over relatively large times indicate that the optical element 34, 36 is intact. Multiple strain measurements that show relatively large change in strain on the optical element 34, 36 over a relatively short times indicate that the optical element 34, 36 is damaged. For example, a crack in the optical element 34, 36 results in a large change in strain on the optical element 34, 36 over a relatively short time. The strain measurements are used to determine whether the optical element 34, 36 is damaged or undamaged and the light emitter 14 is disabled in response to a determination of damage to the optical element 34, 36 to prevent emission of light at undesired intensity from the LiDAR sensor 10. The strain measurements may be repeated to monitor the integrity of the optical element 34, 36.

A method 900 of operating the LiDAR sensor 10 includes repeatedly measuring strain measurements in the optical element 34, 36; determining that the strain measurements indicate that the optical element 34, 36 is intact; enabling the light emitter 14 aimed at the optical element 34, 36 to emit light at the optical element 34, 36 in response to the determination that the optical element 34, 36 is intact; after enabling the light emitter 14, determining that a subsequent one of the strain measurements indicates that the optical element 34, 36 is damaged; and disabling the light emitter 14 in response to the subsequent one of the strain measurements. With method 900, integrity of the optical element 34, 36 may be determined and the light emitter 14 is disabled in response to a determination of damage to the optical element 34, 36 to prevent emission of light at undesired intensity from the LiDAR sensor 10. The method 900 may be repeated to monitor the integrity of the optical element 34, 36.

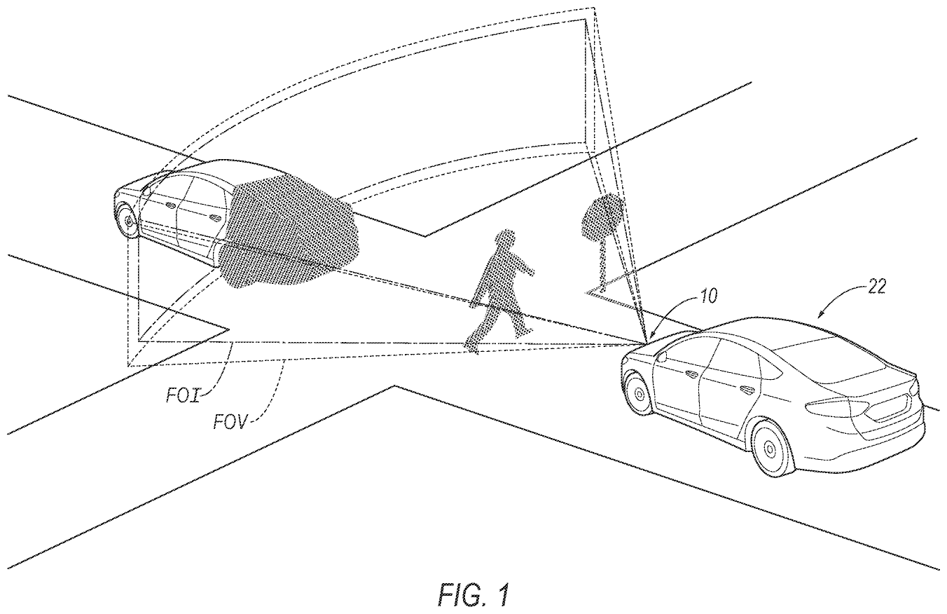

The LiDAR sensor 10 is shown in FIG. 1 as being mounted on a vehicle 20. In such an example, the LiDAR sensor 10 is operated to detect objects in the environment surrounding the vehicle 20 and to detect distance, i.e., range, of those objects for environmental mapping. The output of the LiDAR sensor 10 may be used, for example, to autonomously or semi-autonomously control operation of the vehicle, e.g., propulsion, braking, steering, etc. Specifically, the LiDAR sensor 10 may be a component of or in communication with an advanced driver-assistance system (ADAS) 22 of the vehicle. The LiDAR sensor 10 may be mounted on the vehicle 20 in any suitable position and aimed in any suitable direction. As one example, the LiDAR sensor 10 is shown on the front of the vehicle 20 and directed forward. The vehicle may have more than one LiDAR sensor 10 and/or the vehicle 20 may include other object detection systems, including other LiDAR systems. The vehicle 20 shown in the figures is a passenger automobile. As other examples, the vehicle 20 may be of any suitable manned or un-manned type including a plane, satellite, drone, watercraft, etc.

The LiDAR sensor 10 may be a non-scanning sensor. For example, the LiDAR sensor 10 may be a solid-state LiDAR. In such an example, the LiDAR sensor 10 is stationary relative to the vehicle in contrast to a mechanical LiDAR, also called a rotating LiDAR, that rotates 360 degrees. The solid-state LiDAR sensor, for example, may include a casing 24 that is fixed relative to the vehicle 22, i.e., does not move relative to the component of the vehicle 22 to which the casing 24 is attached, and components of the LiDAR sensor 10 are supported in the casing 24. As a solid-state LiDAR, the LiDAR sensor 10 may be a flash LiDAR sensor. In such an example, the LiDAR sensor 10 emits pulses, i.e., flashes, of light into a field of illumination FOI. More specifically, the LiDAR sensor 10 may be a 3D flash LiDAR sensor that generates a 3D environmental map of the surrounding environment. In a flash LiDAR sensor 10, the FOI illuminates a field of view FOV of the light detector 16. Another example of solid-state LiDAR includes an optical-phase array (OPA). Another example of solid-state LiDAR is a micro-electromechanical system (MEMS) scanning LiDAR, which may also be referred to as a quasi-solid-state LiDAR.

The LiDAR sensor 10 emits infrared light and detects (i.e., with photodetectors 64) the emitted light that is reflected by an object in the field of view FOV, e.g., pedestrians, street signs, vehicles, etc. Specifically, the LiDAR sensor 10 includes a light-emission system 26, a light-receiving system 28, and a controller 30 that controls the light-emission system 26 and the light-receiving system 28. The LiDAR sensor 10 also detects ambient visible light reflected by an object in the field of view FOV (i.e., with photodetectors 64).

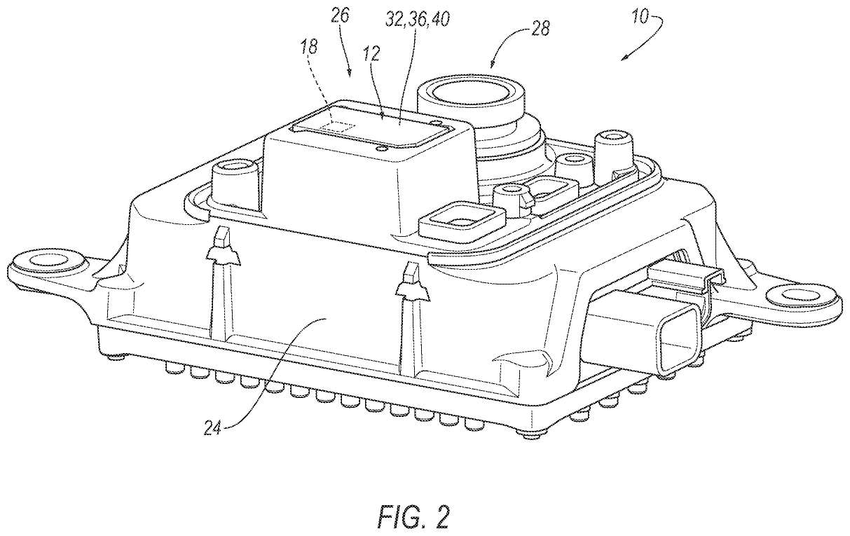

With reference to FIGS. 2-4, the LiDAR sensor 10 may be a unit. Specifically, the casing 24 supports the light-emission system 26 and the light-receiving system 28. The casing 24 may enclose the light-emission system 26 and the light-receiving system 28. The casing 24 may include mechanical attachment features to attach the casing 24 to the vehicle and electronic connections to connect to and communicate with electronic system of the vehicle, e.g., components of the ADAS. At least one exit window 32 extends through the casing 24. Specifically, the casing 24 includes an aperture and the exit window 32 extends across the aperture. The casing 24, for example, may be plastic or metal and may protect the other components of the LiDAR sensor 10 from moisture, environmental precipitation, dust, etc. In the alternative to the LiDAR sensor 10 being a unit, components of the LiDAR sensor 10, e.g., the light-emission system 26 and the light-receiving system 28, may be separated and disposed at different locations of the vehicle.

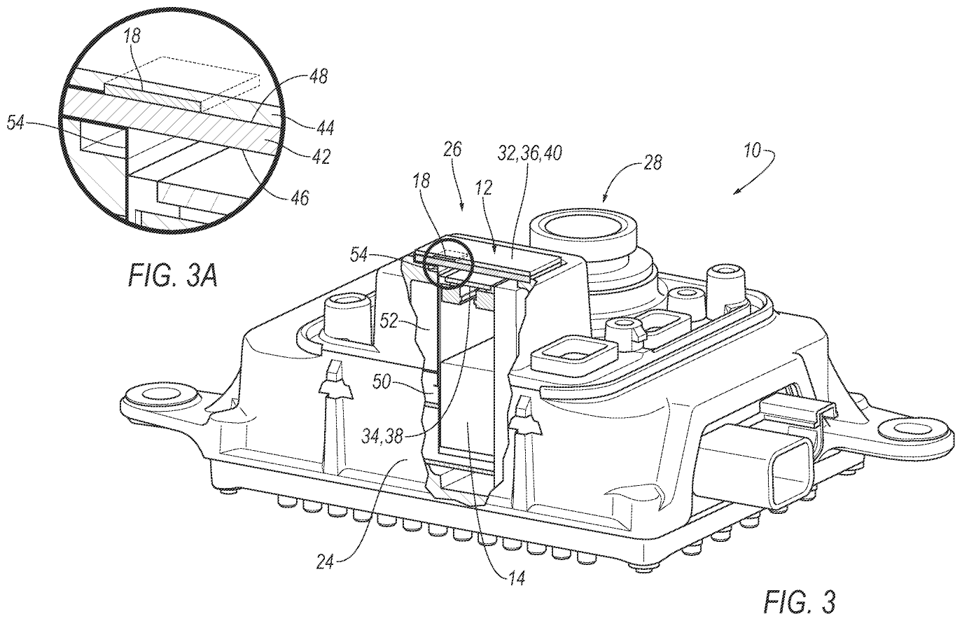

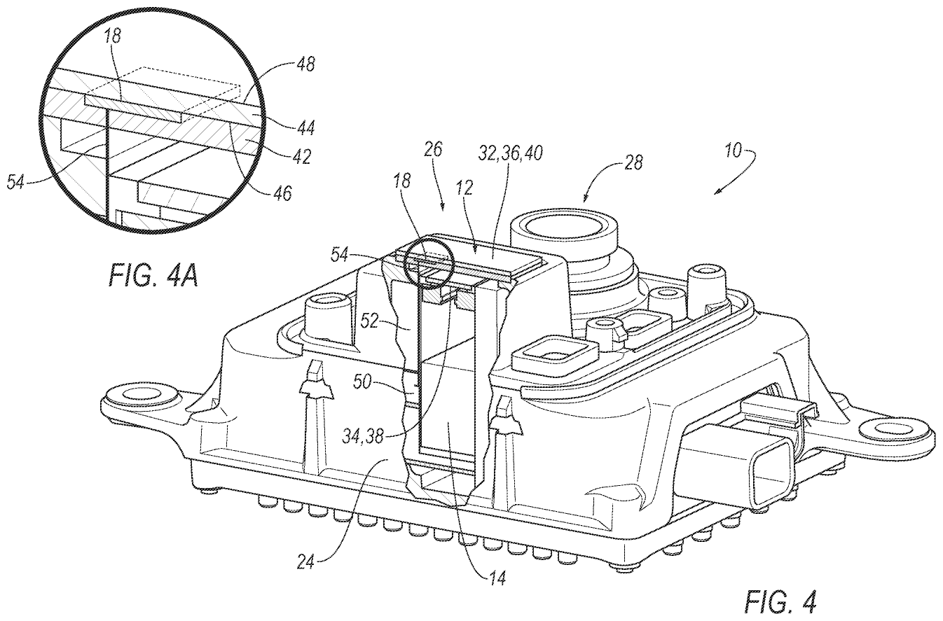

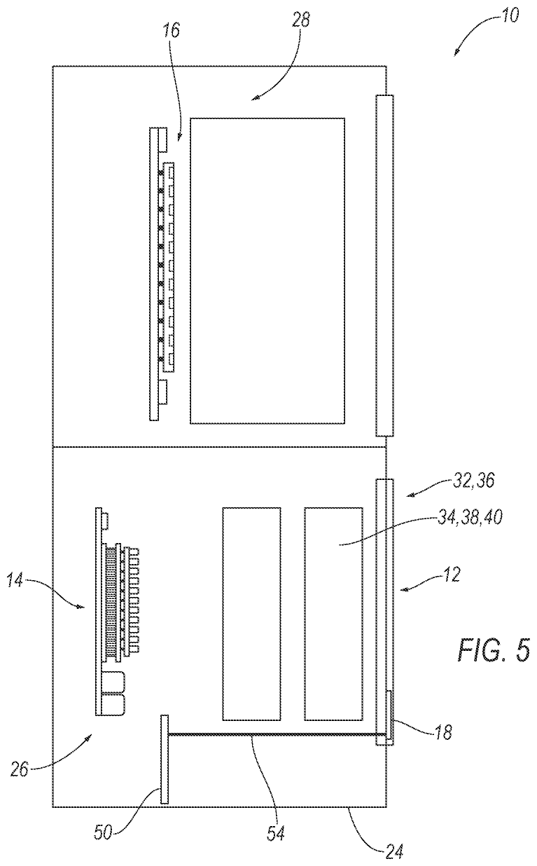

With reference to FIGS. 3-4, the light-emission system 26 may include one or more light emitter 14 and optical components such as a lens package, lens crystal, pump delivery optics, etc. The optical components are between the light emitter 14 and the exit window 32. Thus, light emitted from the light emitter 14 passes through the optical components before exiting the casing 24 through the exit window 32. The optical components include at least one optical element and may include, for example, a collimating lens, transmission optics, etc. The optical components direct, focus, and/or shape the light into the field of illumination FOI.

In the example shown in the figures, the LiDAR sensor 10 includes a first optical element 34 and a second optical element 36. In the example shown in the figures, the exit window 32 is the second optical element 36. As described further below, the first optical element 34 and the second optical element 36 may both be diffusers, i.e., the first optical element 34 is a first diffuser 38 and the second optical element 36 is a second diffuser 40. The adjectives “first” and “second” are used to distinguish between the two optical elements and the adjectives do not signify order or importance. In examples including more than one optical element, the optical elements 34, 36 may be of the same type of different types. Common numerals are used to identify common features of the first optical element 34 and the second optical element 36.

The light emitter 14 is aimed at the optical element 34, 36, i.e., substantially all of the light emitted from the light emitter 14 reaches the optical element 34, 36. The optical element 34, 36 directs the shapes light for illuminating the field of illumination FOI exterior to the LiDAR sensor 10. In other words, the optical element 34, 36 is designed to direct the shaped light to the exit window 32, i.e., is sized, shaped, positioned, and/or has optical characteristics to direct the shape light. As an example, the optical element 34, 36 may be designed to shape the light from the light emitter 14 to be in an elongated pattern into the field of illumination FOI. As one example of shaping the light, the optical element 34, 36 diffuses the light, i.e., spreads the light over a larger path and reduces the concentrated intensity of the light. In other words, in such an example, the optical element 34, 36 is a diffuser that is designed to diffuse the light from the light emitter 14. Light from the light emitter 14 may travel directly from the light emitter 14 to the optical element 34, 36 or may interact with additional components between the light emitter 14 and the optical element 34, 36. The shaped light from the optical element 34, 36 may travel directly to the exit window 32 or may interact with additional components between the optical element 34, 36 the exit window 32 before exiting the exit window 32 into the field of illumination FOI.

The optical element 34, 36 may be of any suitable type that shapes and directs light from the light emitter 14 toward the exit window 32. For example, the optical element 34, 36 may be or include a diffractive optical element, a diffractive diffuser, a refractive diffuser, etc. The optical element 34, 36 is transmissive. In other words, light from the light emitter 14 transmits through the optical element 34, 36. In such an example, the optical element 34, 36 may be transparent.

In the example shown in the figures in which the first optical element 34 is a first diffuser 38 and the second optical element 36 is a second diffuser 40, light from the light emitter 14 travels through the first diffuser 38 before traveling through the second diffuser 40. The first diffuser 38 diffuses the light and directs the light, either directly or indirectly, to the second diffuser 40. The second diffuser 40 diffuses the light and, in the example in the figures in which the second optical element 36 i.e., the second diffuser 40, is the exit window 32, the second diffuser 40 directs the light into the field of illumination exterior to the LiDAR sensor 10. The first optical element 34 may be spaced from the second optical element 36, as shown in in the example in the figures.

The strain gauge 18 may be encapsulated on the optical element 34, 36. In the example shown in the figures, the strain gauge 18 is encapsulated on the second optical element 36. In other examples, the strain gauge may be encapsulated on the first optical element 34 in addition or in the alternative to the strain gauge 18 being encapsulated on the second optical element 36. In such examples, one strain gauge 18 is encapsulated on one optical element and another strain gauge 18 is encapsulated on the other optical element.

The optical element 34, 36 may include a base layer 42 and a second layer 44 encapsulating the strain gauge 18 on the base layer 42. The base layer 42 may be polymeric. As one example, the base layer 42 may be polycarbonate or any other suitable type of polymeric material. As other examples, the base layer 42 may be glass or any other suitable type of material. The second layer 44 may be polymeric. As an example, the second layer 44 may be polycarbonate or any other suitable polymeric material that can be applied to the base layer 42 to encapsulate the strain gauge 18 on the base layer 42. The second layer 44 may be applied to the base layer 42 by, for example, over-molding. In such an example, the optical element 34, 36 is over-molded, specifically, the second layer 44 is over-molded. “Over-molded” is a structural description optical element and the second layer 44, not the process by which the optical element 34, 36 and the second layer 44 is made. In other words, the over-molded optical element and second layer 44 has the structure of an over-molded component. When over-molded, the second layer 44 may be a single, uniform piece of material with no seams or joints and may be fixed to the base layer 42 without fasteners or adhesives holding the second layer 44 and the base layer 42 together. In such an example, the second layer 44 has a shape that conforms to a mold, e.g., an injection mold, used to form the second layer 44 as an over-molded component to the base layer 42. In other examples, the second layer 44 is not over-molded and is fixed to the base layer 42 by fusing, adhesive, etc.

In the example shown in the figures, the base layer 42 has an inboard side 46 and the outboard side 48. The strain gauge 18 may be on the outboard side 48 of the base layer 42 and the second layer 44 may be on the outboard side 48, as shown in the example in FIGS. 3 and 3A. In such an example, the second layer 44 encapsulates the strain gauge 18 on the outboard side 48 of the base layer 42. As another example, the strain gauge 18 may be on the inboard side 46 of the base layer 42 and the second layer 44 may be in the inboard side 46, as shown in the example in FIGS. 4 and 4A. In such an example, the second layer 44 encapsulates the strain gauge 18 on the inboard side 46 of the base layer 42.

With reference to FIG. 4, the LiDAR sensor 10 includes a printed-circuit board 50 below the optical element 34, 36. Specifically, a cavity 52 houses the printed-circuit board 50 and the optical element 34, 36. The cavity 52 may also house all or some other components of the light-emission system 26. The controller 30 may be on the printed-circuit board 50. In the example shown in FIG. 4, the strain gauge 18 is on the inboard side 46 of the base layer 42 and the strain gauge 18 is directly connected to the printed-circuit board 50. Specifically, the leads 54 from the strain gauge 18 travel uninterrupted through the cavity 52 from the strain gauge 18 to the printed-circuit board 50.

The optical element 34, 36 includes a light-shaping region 12. The light emitter 14 is aimed at the light-shaping region 12, i.e., directly or indirectly as described above. The light-shaping region 12 of the optical element 34, 36 shapes light that is emitted from the light emitter 14. As one example of shaping the light, the light-shaping region 12 of the optical element 34, 36 diffuses the light, i.e., spreads the light over a larger path and reduces the concentrated intensity of the light. In other words, the light-shaping region 12 of the optical element 34, 36 is designed to diffuse the light from the light emitter 14.

The light-emission system 26 includes the strain gauge 18. As set forth above, the strain gauge 18 is on the optical element 34, 36. Specifically, the strain gauge 18 is fixed to the optical element 34, 36 and moves with the optical element 34, 36. For example, as described above, the strain gauge 18 may be on the outboard side 48 of the base layer 42 or may be on the inboard side 46 of the base layer 42. The encapsulation of the strain gauge on the base layer 42 forces the strain gauge 18 to move with the base layer 42, which allows the strain gauge 18 to measure the strain on the base layer 42.

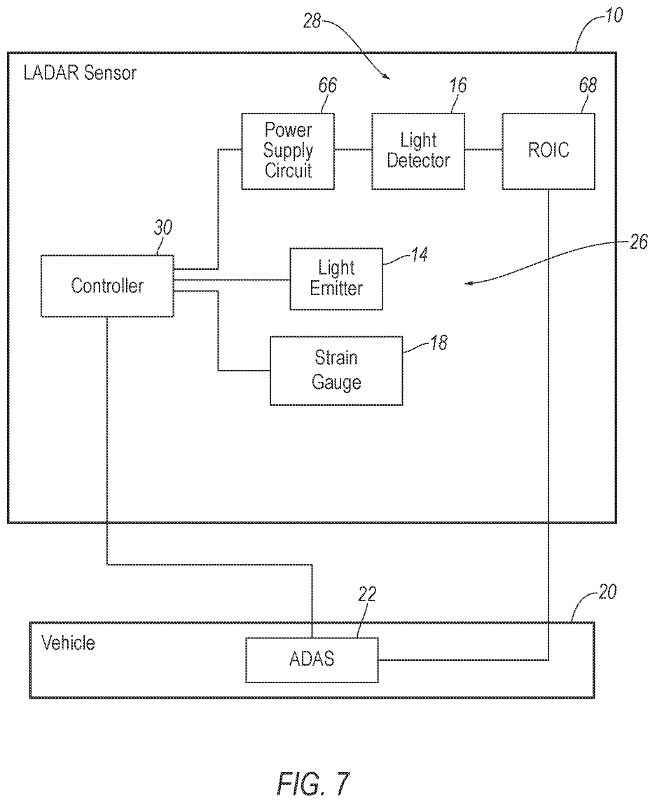

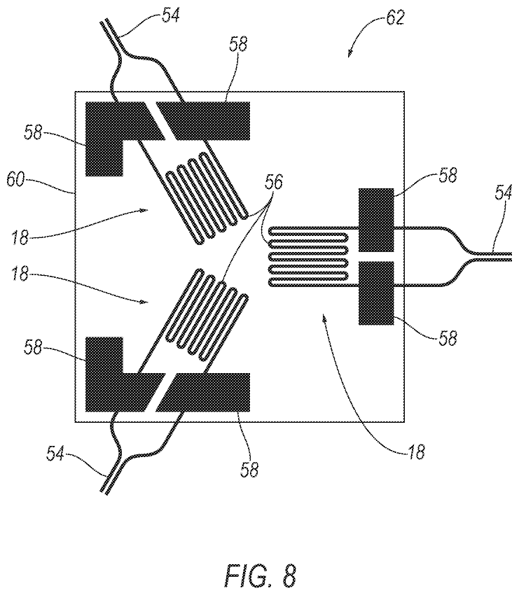

The strain gauge 18 measures strain on the optical element 34, 36. With reference to FIG. 8, the strain gauge 18 includes a line 56 of conductive material in a zig-zag pattern and pads 58 at each end of the line 56 of conductive material. Electrical resistance across the pads 58 is measured, e.g., with a Wheatstone bridge connected to the pads 58 by leads 54. The electrical resistance through the conductive material changes as the strain gauge 18 moves, i.e., as the base layer 42 moves, so that changes in electrical resistance through the line 56 of conductive material is a measure of strain on the base layer 42. As shown in FIG. 7, the strain gauge 18 is in communication with the controller 30 so that the controller 30 may receive data from the strain gauge 18 indicating strain on the optical element 34, 36. The line 56 of conductive material is elongated, i.e., relatively long and thin, to move with the base layer 42. The line 56 of conductive material may be thin, e.g., a foil. The line 56 of conductive material may be, for example, any type of suitable conductive metal alloy. The line 56 of conductive material may be supported by a backing 60 that is not electrically conductive, e.g., a polymeric backing. The backing 60 is flexible, i.e., flexible relative to the base layer 42 of the optical element 34, 36. The backing 60 is fixed to the optical element 34, 36, e.g., the base layer 42, by adhesive and/or encapsulation by the second layer 44. In such an example, the backing 60 and the line 56 of conductive material move together as a unit with the surface of the base layer 42 to which the strain gauge 18 is fixed.

The strain gauge 18 may be outside of the light-shaping region 12 to avoid interference with the shaping of the light from the light emitter 14. Damage to the optical element 34, 36 in the light-shaping region 12 is detected by the strain gauge 18 outside of the light-shaping region 12 as damage at the light-shaping region 12 affects strain on the optical element 34, 36 including outside of the light-shaping region 12,

The light-emission system 26 may include multiple strain gauges 18, as shown in the example in FIG. 8. The multiple strain gauge 18s, in combination, may be referred to as a gauge assembly 62. Each strain gauge 18 is sensitive to movement along the zig-zags of the conductive material. Accordingly, the multiple strain gauges 18 measure strain on the optical element 34, 36 in multiple directions to provide a robust strain measurement of the optical element 34, 36. In an example, including multiple strain gauges 18, each of the multiple strain gauges 18 is in communication with the controller 30. Common numerals are used to identify common features of the strain gauges 18 in FIG. 8.

As described further below, the controller 30 controls operation of the light emitter 14 based on measurements from the strain gauge 18. Specifically, the controller 30 continues operation of the light emitter 14, i.e., emits light from the light emitter 14, when the strain measurements indicate that the optical element 34, 36 is intact, i.e., undamaged, and the controller 30 disables the light emitter 14 when the strain gauge 18 indicates that the optical element 34, 36 is damaged, e.g., cracked.

The light emitter 14 emits light for illuminating objects for detection. The light-emission system 26 may include a beam-steering device (not shown) between the light emitter 14 and the window. The controller 30 is in communication with the light emitter 14 for controlling the emission of light from the light emitter 14 and, in examples including a beam-steering device, the controller 30 is in communication with the beam-steering device for aiming the emission of light from the LiDAR sensor 10 into the field of illumination FOI.

The light emitter 14 emits light into the field of illumination FOI for detection by the light-receiving system 28 when the light is reflected by an object in the field of view FOV. In the example in which the LiDAR sensor 10 is flash LiDAR, the light emitter 14 emits shots, i.e., pulses, of light into the field of illumination FOI for detection by the light-receiving system 28 when the light is reflected by an object in the field of view FOV to return photons to the light-receiving system 28. Specifically, the light emitter 14 emits a series of shots. As an example, the series of shots may be 1,500-2,500 shots. The light-receiving system 28 has a field of view FOV that overlaps the field of illumination FOI and receives light reflected by surfaces of objects, buildings, road, etc., in the FOV. In other words, the light-receiving system 28 detects shots emitted from the light emitter 14 and reflected in the field of view FOV back to the light-receiving system 28, i.e., detected shots. The light emitter 14 may be in electrical communication with the controller 30, e.g., to provide the shots in response to commands from the controller 30.

The light emitter 14 may be, for example, a laser. The light emitter 14 may be, for example, a semiconductor light emitter 14, e.g., laser diodes. In one example, the light emitter 14 is a vertical-cavity surface-emitting laser (VCSEL). As another example, the light emitter 14 may be a diode-pumped solid-state laser (DPSSL). As another example, the light emitter 14 may be an edge emitting laser diode. The light emitter 14 may be designed to emit a pulsed flash of light, e.g., a pulsed laser light. Specifically, the light emitter 14, e.g., the VCSEL or DPSSL or edge emitter, is designed to emit a pulsed laser light or train of laser light pulses. In examples in which the first optical element 34 and the second optical element 36 are diffusers, the light emitted by the light emitter 14 is diffused by the first optical element 34 and the second optical, as described above. The light emitted by the light emitter 14 may be, for example, infrared light. Alternatively, the light emitted by the light emitter 14 may be of any suitable wavelength. The LiDAR sensor 10 may include any suitable number of light emitter 14s, i.e., one or more in the casing 24. In examples that include more than one light emitter 14, the light emitter 14s may be arranged in a column or in columns and rows. In examples that include more than one light emitter 14, the light emitters 14 may be identical or different and may each be controlled by the controller 30 for operation individually and/or in unison.

As set forth above, the light emitter 14 is aimed, directly or indirectly, at the optical element 34, 36, and more specifically, at the first optical element 34 and the second optical element 36 in the example shown in the figures. The light emitter 14 may be stationary relative to the casing 24. In other words, the light emitter 14 does not move relative to the casing 24 during operation of the LiDAR sensor 10, e.g., during light emission. The light emitter 14 may be mounted to the casing 24 in any suitable fashion such that the light emitter 14 and the casing 24 move together as a unit.

The light-receiving system 28 has a field of view FOV that overlaps the field of illumination FOI and receives light reflected by objects in the FOV. Stated differently, the field of illumination FOI generated by the light-emitting system overlaps the field of view of the light-receiving system 28. The light-receiving system 28 may include receiving optics and a light detector 16 having the array of photodetectors 64. The light-receiving system 28 may include a receiving window and the receiving optics may be between the receiving window and the light detector 16. The receiving optics may be of any suitable type and size.

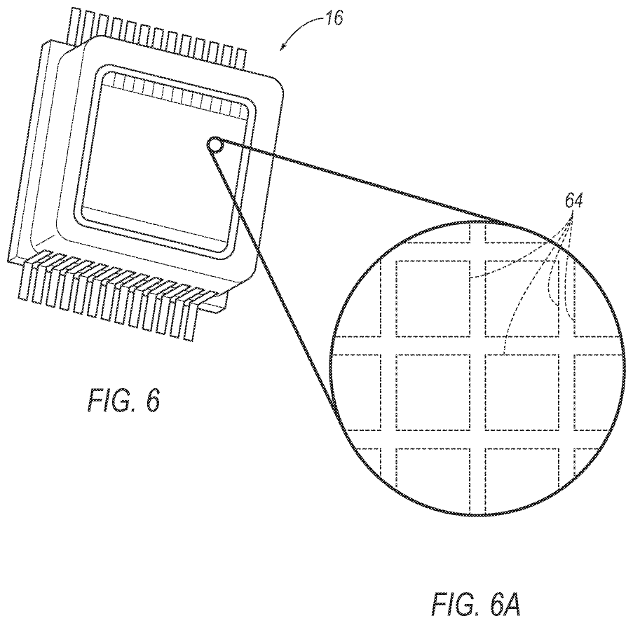

The light detector 16 includes a chip (which may be the same as the printed-circuit board 50 described above) and the array of photodetectors 64 is on the chip, as described further below. The chip may be silicon (Si), indium gallium arsenide (InGaAs), germanium (Ge), etc., as is known. The chip and the photodetectors 64 are shown schematically. The array of photodetectors 64 is 2-dimensional. Specifically, the array of photodetectors 64 includes a plurality of photodetectors 64 arranged in a columns and rows (schematically shown in FIGS. 6 and 6A).

Each photodetector 64 is light sensitive. Specifically, each photodetector 64 detects photons by photo-excitation of electric carriers. An output signal from the photodetector 64 indicates detection of light and may be proportional to the amount of detected light. The output signals of each photodetector 64 are collected to generate a scene detected by the photodetector 64.

The photodetector 64 may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors 64, phototransistors, photoconductive detectors, phototubes, photomultipliers, etc. The photodetectors 64 may each be of the same type.

Avalanche photo diodes (APD) are analog devices that output an analog signal, e.g., a current that is proportional to the light intensity incident on the detector. APDs have high dynamic range as a result but need to be backed by several additional analog circuits, such as a transconductance or transimpedance amplifier, a variable gain or differential amplifier, a high-speed A/D converter, one or more digital signal processors (DSPs) and the like.

In examples in which the photodetectors 64 are SPADs, the SPAD is a semiconductor device, specifically, an APD, having a p-n junction that is reverse biased (herein referred to as “bias”) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates the arrival time of the detected photon. In other words, the SPAD is a triggering device of which usually the leading edge determines the trigger.

The SPAD operates in Geiger mode. “Geiger mode” means that the APD is operated above the breakdown voltage of the semiconductor and a single electron-hole pair (generated by absorption of one photon) can trigger a strong avalanche. The SPAD is biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by a power-supply circuit 66 to a voltage above the SPAD breakdown voltage so that the next photon can be detected.

Each photodetector 64 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the field of view FOVs. By merging these distances with the position of photodetectors 64 at which these data originated and relative positions of these photodetectors 64 at a time that these data were collected, the LiDAR sensor 10 (or other device accessing these data) can reconstruct a three-dimensional (virtual or mathematical) model of a space occupied by the LiDAR sensor 10, such as in the form of 3D image represented by a rectangular matrix of range values, wherein each range value in the matrix corresponds to a polar coordinate in 3D space. Each photodetector 64 can be configured to detect a single photon per sampling period, e.g., in the example in which the photodetector 64 is a SPAD. The photodetector 64 functions to output a single signal or stream of signals corresponding to a count of photons incident on the photodetector 64 within one or more sampling periods. Each sampling period may be picoseconds, nanoseconds, microseconds, or milliseconds in duration. The photodetector 64 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the fields of view of these photodetectors 64. By merging these distances with the position of photodetectors 64 at which these data originated and relative positions of these photodetectors 64 at a time that these data were collected, the controller 30 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

With reference to FIGS. 6 and 6A, the photodetectors 64 may be arranged as an array, e.g., a 2-dimensional arrangement. A 2D array of photodetectors 64 includes a plurality of photodetectors 64 arranged in columns and rows. Specifically, the light detector 16 may be a focal-plane array (FPA).

The light detector 16 includes a plurality of pixels. Each pixel may include one or more photodetectors 64. The pixels each including a power-supply circuit 66 and a read-out integrated circuit (ROIC 68). The photodetectors 64 are connected to the power-supply circuit 66 and the ROIC 68. Multiple pixels may share a common power-supply circuit 66 and/or ROIC 68.

The light detector 16 detects photons by photo-excitation of electric carriers. An output from the light detector 16 indicates a detection of light and may be proportional to the amount of detected light, in the case of a PIN diode or APD, and may be a digital signal in case of a SPAD. The outputs of light detector 16 are collected to generate a 3D environmental map, e.g., 3D location coordinates of objects and surfaces within the field of view FOV of the LiDAR sensor 10.

With reference to FIG. 7, the ROIC 68 converts an electrical signal received from photodetectors 64 of the FPA to digital signals. The ROIC 68 may include electrical components which can convert electrical voltage to digital data. The ROIC 68 may be connected to the controller 30, which receives the data from the ROIC 68 and may generate 3D environmental map based on the data received from the ROIC 68.

The power-supply circuit 66s supply power to the photodetectors 64. The power-supply circuit 66 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 66 may supply power to the photodetectors 64 in a first voltage range that is higher than a second operating voltage of the ROIC 68. The power-supply circuit 66 may receive timing information from the ROIC 68.

The light detector 16 may include one or more circuits that generates a reference clock signal for operating the photodetectors 64. Additionally, the circuit may include logic circuits for actuating the photodetectors 64, power-supply circuit 66, ROIC 68, etc.

As set forth above, the light detector 16 includes a power-supply circuit 66 that powers the pixels. The light detector 16 may include a single power-supply circuit 66 in communication with all pixels or may include a plurality of power-supply circuit 66s in communication with a group of the pixels.

The power-supply circuit 66 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 66 may include a power-supply control circuit. The power-supply control circuit may include electrical components such as a transistor, logical components, etc. The power-supply control circuit may control the power-supply circuit 66, e.g., in response to a command from the controller 30, to apply bias voltage and quench and reset the SPAD.

In examples in which the photodetector 64 is an avalanche-type photodiode, e.g., a SPAD, to control the power-supply circuit 66 to apply bias voltage, quench, and reset the avalanche-type diodes, the power-supply circuit 66 may include a power-supply control circuit. The power-supply control circuit may include electrical components such as a transistor, logical components, etc. A bias voltage, produced by the power-supply circuit 66, is applied to the cathode of the avalanche-type diode. An output of the avalanche-type diode, e.g., a voltage at a node, is measured by the ROIC 68 circuit to determine whether a photon is detected. The power-supply circuit 66 supplies the bias voltage to the avalanche-type diode based on inputs received from a driver circuit of the ROIC 68. The ROIC 68 may include the driver circuit to actuate the power-supply circuit 66, an analog-to-digital (ADC) or time-to-digital (TDC) circuit to measure an output of the avalanche-type diode at the node, and/or other electrical components such as volatile memory (register), and logical control circuits, etc. The driver circuit may be controlled based on an input received from the circuit of the light detector 16, e.g., a reference clock. Data read by the ROIC 68 may be then stored in, for example, a memory chip. A controller 30, e.g., the controller 30, a controller 30 of the LiDAR sensor 10, etc., may receive the data from the memory chip and generate 3D environmental map, location coordinates of an object within the field of view FOV of the LiDAR sensor 10, etc.

The controller 30 actuates the power-supply circuit 66 to apply a bias voltage to the plurality of avalanche-type diodes. For example, the controller 30 may be programmed to actuate the ROIC 68 to send commands via the ROIC 68 driver to the power-supply circuit 66 to apply a bias voltage to individually powered avalanche-type diodes. Specifically, the controller 30 supplies bias voltage to avalanche-type diodes of the plurality of pixels of the focal-plane array through a plurality of the power-supply circuit 66s, each power-supply circuit 66 dedicated to one of the pixels, as described above. The individual addressing of power to each pixel can also be used to compensate manufacturing variations via look-up-table programmed at an end-of-line testing station. The look-up-table may also be updated through periodic maintenance of the LiDAR sensor 10.

The controller 30 is in electronic communication with the pixels (e.g., with the ROIC 68 and power-supply circuit 66) and the vehicle (e.g., with the ADAS) to receive data and transmit commands. The controller 30 may be configured to execute operations disclosed herein.

The controller 30 is a physical, i.e., structural, component of the LiDAR sensor 10. The controller 30 may be a microprocessor-based controller 30, an application specific integrated circuit (ASIC), field programmable gate array (FPGA), etc., or a combination thereof, implemented via circuits, chips, and/or other electronic components.

For example, the controller 30 may include a processor, memory, etc. In such an example, the memory of the controller 30 may store instructions executable by the processor, i.e., processor-executable instructions, and/or may store data. The memory includes one or more forms of controller 30-readable media, and stores instructions executable by the controller 30 for performing various operations, including as disclosed herein. As another example, the controller 30 may be or may include a dedicated electronic circuit including an ASIC (application specific integrated circuit) that is manufactured for a particular operation, e.g., calculating a histogram of data received from the LiDAR sensor 10 and/or generating a 3D environmental map for a field of view FOV of the light detector 16 and/or an image of the field of view FOV of the light detector 16. As another example, the controller 30 may include an FPGA (field programmable gate array) which is an integrated circuit manufactured to be configurable by a customer. As an example, a hardware description language such as VHDL (very high speed integrated circuit hardware description language) is used in electronic design automation to describe digital and mixed-signal systems such as FPGA and ASIC. For example, an ASIC is manufactured based on hardware description language (e.g., VHDL programming) provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 30 may be a set of controller 30s communicating with one another via a communication network of the vehicle, e.g., a controller 30 in the LiDAR sensor 10 and a second controller 30 in another location in the vehicle.

The controller 30 may be in communication with the communication network of the vehicle to send and/or receive instructions from the vehicle, e.g., components of the ADAS. The controller 30 is programmed to perform the method 1100 and function described herein and shown in the figures. For example, in an example including a processor and a memory, the instructions stored on the memory of the controller 30 include instructions to perform the method 1100 and function described herein and shown in the figures; in an example including an ASIC, the, the hardware description language (e.g., VHDL) and/or memory electrically connected to the circuit include instructions to perform the method 1100 and function described herein and shown in the figures; and in an example including an FPGA, the hardware description language (e.g., VHDL) and/or memory electrically connected to the circuit include instructions to perform the method 1100 and function described herein and shown in the figures. Use herein of “based on,” “in response to,” and “upon determining,” indicates a causal relationship, not merely a temporal relationship.

The controller 30 may provide data, e.g., a 3D environmental map and/or images, to the ADAS of the vehicle and the ADAS may operate the vehicle in an autonomous or semi-autonomous mode based on the data from the controller 30. For purposes of this disclosure, an autonomous mode is defined as one in which each of vehicle propulsion, braking, and steering are controlled by the controller 30 and in a semi-autonomous mode the controller 30 controls one or two of vehicle propulsion, braking, and steering. In a non-autonomous mode a human operator controls each of vehicle propulsion, braking, and steering.

The controller 30 may include or be communicatively coupled to (e.g., through the communication network) more than one processor, e.g., controller 30s or the like included in the vehicle for monitoring and/or controlling various vehicle controller 30s, e.g., a powertrain controller 30, a brake controller 30, a steering controller 30, etc. The controller 30 is generally arranged for communications on a vehicle communication network that can include a bus in the vehicle such as a controller 30 area network (CAN) or the like, and/or other wired and/or wireless mechanisms.

The controller 30 is programmed to control operation of the light emitter 14 based on detection by the strain gauge 18 of strain on the optical element 34, 36, i.e., based on strain measurements taken by the strain gauge 18. Specifically, the controller 30 is programmed to enable the light emitter 14 based on detection by the strain gauge 18 of strain on the optical element 34, 36 indicating that the optical element 34, 36 is intact and to disable the light emitter 14 based on detection by the strain gauge 18 of damage to the optical element 34, 36. Accordingly, the controller 30 prevents operation of the LiDAR sensor 10 when the optical element 34, 36 is damaged to avoid emission of light at undesired intensity from the LiDAR sensor 10.

The controller 30 repeats the strain measurements by the strain gauge 18. This allows for continuous monitoring of the integrity of the optical element 34, 36. The continuous monitoring of the integrity of the optical element 34, 36 allows for the immediate disablement of the LiDAR sensor 10 when damage to the optical element 34, 36 is detected. As an example, the controller 30 may be programmed to repeat the strain measurement to confirm the integrity of the optical element 34, 36 before each activation of the light emitter 14, i.e., after a previous emission by the light emitter 14 and before the next emission by the light emitter 14. In other words, for each firing of the light emitter 14, the controller 30 may be programmed to first measure the strain on the optical element 34, 36 and activate the light emitter 14 in response to identification that strain measurement indicates that the optical element 34, 36 is intact. As another example, the controller 30 may periodically repeat the strain measurements of the optical element 34, 36 to confirm the integrity of the optical element 34, 36 based on time, number of light emitter 14 firings, etc.

As set forth above, the controller 30 is programmed to activate the light emitter 14 to emit light into the field of illumination. Specifically, the controller 30 is programmed to enable the light emitter 14 based on strain measurements by the strain gauge 18 indicating that the optical element 34, 36 is intact. The controller 30 enables the light emitter 14, for example, by allowing activation of the light emitter 14, or providing instruction to the light emitter 14 to emit light, etc.

As set forth above, the controller 30 is programmed to disable the light emitter 14 based on a strain measurement by the strain gauge 18 indicating that the optical element 34, 36 is damaged, e.g., cracked. The controller 30 may disable the light emitter 14, for example, by preventing activation of the light emitter 14, or deciding not to provide instructions to the light emitter 14, etc. When the light emitter 14 is disabled, the light emitter 14 does not emit light into the field of illumination of the LiDAR sensor 10. In response to disablement of the light emitter 14, the controller 30 may instruct the ADAS that the light emitter 14 is disabled.

In the event the optical element 34, 36 is damaged, one strain measurement by itself may indicate that the optical element 34, 36 is damaged or one of the strain measurements in comparison with one or more other strain measurements may indicate the optical element 34, 36 is damaged. For example, the controller 30 may compare each strain measurement to a threshold value. In such an example, a strain measurement by the strain gauge 18 that is above the threshold value is used as an indication by the controller 30 that the optical element 34, 36 is damaged. Specifically, damage near the strain gauge 18 may increase the detected strain by the strain gauge 18 above the threshold value. The threshold value may be a predetermined value stored by the controller 30 and, for example, may be based on empirical data, modelled data, etc.

As another example, the controller 30 may compare each strain measurement to a range of values. In such an example, a strain measurement by the strain gauge 18 that is outside of the range of values, e.g., above or below the range, is used as an indication by the controller 30 that the optical element 34, 36 is damaged. As an example, damage to the optical element 34, 36 near the strain gauge 18 may increase the detected strain by the strain gauge 18 above the range of values and damage to the optical element 34, 36 spaced farther from the strain gauge 18 may decrease the detected strain by the strain gauge 18 below the range of values. The range of values may be predetermined values stored by the controller 30 and, for example, may be based on empirical data, modelled data, etc.

As another example, the controller 30 may compare each strain measurement with one or more previous strain measurements. For example, the controller 30 may compare a strain measurement to one or more of the previous strain measurements and disable the light emitter 14 in response to a determination that the variation of the most recent strain measurement relative to one or more previous strain measurements exceeds a predetermined threshold value. For example, a drastic increase or decrease of the strain measurement in comparison to one or more previous strain measurements indicates damage to the optical element 34, 36. Such an indication may be based on changes in the strain measurements over time. Specifically, the controller 30 may compare a strain measurement to one or more of the previous strain measurements and disable the light emitter 14 in response to a determination that the variation of the most recent strain measurement relative to one or more previous strain measurements exceeds a predetermined threshold value over a predetermined period of time. In such an example, the predetermined threshold value and the predetermined period of time may be based on empirical data, modelled data, etc.

As one example, one strain measurement may be compared to one previous strain measurement. Specifically, in such an example, the controller 30 disables the light emitter 14 in response to a determination that the value of the difference between the strain measurement and the previous strain measurement exceeds a predetermined threshold value. As another example, one strain measurement may be compared to a plurality of previous strain measurements. For example, the controller 30 may use previous strain measurements to determine a pattern of the previous strain measurements (i.e., a mean, a median, a standard deviation, etc.) and a drastic deviation from the pattern of previous strain measurements indicates damage to the optical element 34, 36. A drastic deviation for the pattern of previous strain measurements may be a deviation, e.g., deviation from mean, median, standard deviation, etc., that exceeds a predetermined percentage. The predetermined percentage may be based on empirical data, modelled data, etc. As another example, the controller 30 disables the light emitter 14 in response to a determination that the deviation from the pattern of previous strain measurements exceeds a predetermined threshold value.

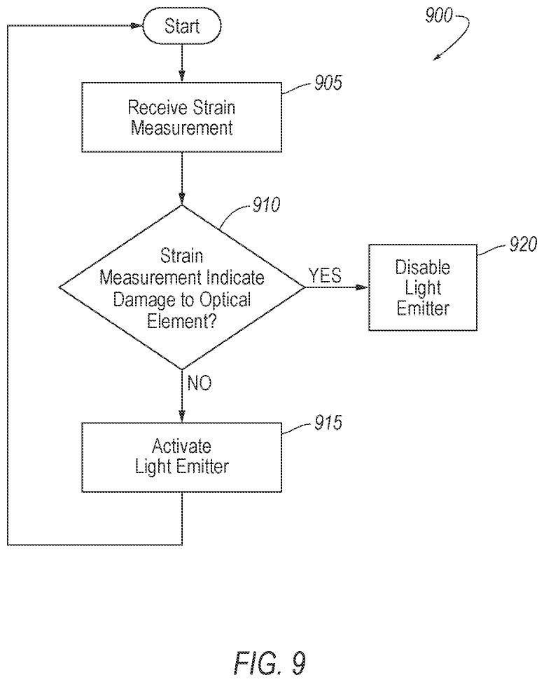

As set forth above, the controller 30 is programmed to perform the method 900 shown in FIG. 9. With reference to FIG. 9, the method includes controlling the light emitter 14 based on confirmation, or lack thereof, of the integrity of the optical element 34, 36, i.e., whether the optical element 34, 36 is intact or damaged.

With reference to block 905, the method 900 includes receiving a strain measurement from the strain gauge 18. Specifically, the controller 30 receives the strain measurement from the strain gauge 18. The controller 30 may instruct the strain gauge 18 to take the strain measurement and may record the measurement taken by the strain gauge 18. In the example shown in the figures, the method 900 proceeds to block 910 after receipt of the strain measurement and it should be appreciated that one or more strain measurements may be measured and received by the controller 30 before proceeding to block 910.

During operation of the LiDAR sensor 10 while the optical element 34, 36 is intact, the method 900 includes repeatedly determining that the strain measurement indicates that the optical element 34, 36 is intact (block 910) and enabling the light emitter 14 based on the determination that the optical element 34, 36 is intact (block 915). As an example, the method 900 may be repeated before each activation of the light emitter 14. In other words, for each firing of the light emitter 14, the method 900 may include first receiving a strain measurement dedicated to that firing. As another example, the method 900 may include periodically receiving strain measurements to confirm the integrity of the optical element 34, 36 based on time, number of light emitter 14 firings, etc. In other words, the method 900 may include repeating the receipt of strain measurements on regular time intervals, after a predetermined number of light emitter 14 firings, etc.

As set forth above, the method 900 includes enabling the light emitter 14 based on the determination that the strain measurement indicates that the optical element 34, 36 is intact. As set forth above, the controller 30 enables the light emitter 14, for example, by allowing activation of the light emitter 14, or providing instruction to the light emitter 14 to emit light, etc.

The method 900 includes disabling the light emitter 14 when the optical element 34, 36 is damaged. As an example, after repeatedly enabling the light emitter 14 in blocks 910 and 915 as discussed above, the method 900 includes determining that a subsequent one of the strain measurements indicates that the optical element 34, 36 is damaged in block 915. With reference to block 920, the method includes disabling the light emitter 14 in response to the subsequent one of the strain measurements that indicates that the optical element 34, 36 is damaged.

With continued reference to block 910, the method 900 may include determining that the strain measurement indicates damage to the optical element 34, 36 by either evaluating one strain measurement by itself for indication that the optical element 34, 36 is damaged or by evaluating one of the strain measurements in comparison with one or more other strain measurements for indication that the optical element 34, 36 is damaged, as described above. For example, the controller 30 may compare each strain measurement to a threshold value or a range of values, as described above. In such an example, a strain measurement by the strain gauge 18 that is above the threshold value or outside of the range of is used as an indication by the controller 30 that the optical element 34, 36 is damaged. As another example the method 900 may include determining that the value of the difference between the subsequent one of the strain measurements and at least one previous strain measurement exceeds a predetermined threshold value over a predetermined period of time.

With continued reference to block 910, as another example, the method may include using previous strain measurements to determine a pattern of the previous strain measurements (i.e., a mean, a median, a standard deviation, etc.). In such an example, the method includes determining that a drastic deviation from the pattern of previous strain measurements indicates damage to the optical element 34, 36, as described above.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A LIDAR sensor comprising:
an optical element having a light-shaping region;
a light emitter aimed at the optical element, the optical element directing light from the light emitter into a field of illumination;
a light detector having a field of view overlapping the field of illumination; and
a strain gauge on the optical element.

2. The LiDAR sensor as set forth in claim 1, wherein the optical element includes a base layer and a second layer encapsulating the strain gauge on the base layer.

3. The LiDAR sensor as set forth in claim 1, wherein the optical element has an inboard side and an outboard side, the light emitter being aimed at the inboard side and the strain gauge being on the inboard side.

4. The LiDAR sensor as set forth in claim 3, wherein the optical element includes a base layer having the inboard side and the outboard side and a second layer on the inboard side, the second layer encapsulating the strain gauge on the inboard side.

5. The LiDAR sensor as set forth in claim 1, further comprising a controller programmed to control operation of the light emitter based on detection by the strain gauge of strain on the optical element.

6. The LiDAR sensor as set forth in claim 5, further comprising a printed-circuit board, the controller being on the printed circuit board, the strain gauge being directly connected to the printed-circuit board.

7. The LiDAR sensor as set forth in claim 1, further comprising a controller programmed to disable the light emitter based on detection by the strain gauge of damage to the optical element.

8. The LiDAR sensor as set forth in claim 1, further comprising a controller programmed to enable the light emitter based on detection by the strain gauge of strain on the optical element indicating that the optical element is intact.

9. The LiDAR sensor as set forth in claim 8, wherein the controller is programmed to disable the light emitter based on detection by the strain gauge of damage to the optical element.

10. The LiDAR sensor as set forth in claim 1, further comprising a controller programmed to:
repeatedly measure strain measurements of the optical element; and
disable the light emitter in response to a determination that a variation of one of the strain measurements in comparison to one or more previous strain measurements indicates that the optical element is damaged.

11. The LiDAR sensor as set forth in claim 10, wherein the determination that the variation indicates that the optical element is damaged includes a determination of the value of the difference between the one of the strain measurements and one previous strain measurement exceeds a predetermined threshold

12. The LiDAR sensor as set forth in claim 10, wherein the determination that the variation indicates that the optical element is damaged includes a determination that the one of the strain measurements deviates from a pattern of a plurality of previous strain measurements.

13. The LiDAR sensor as set forth in claim 1, wherein the light-shaping region is transparent.

14. The LiDAR sensor as set forth in claim 1, wherein the strain gauge is outside of the light-shaping region.

15. The LiDAR sensor as set forth in claim 1, wherein the optical element is a diffuser.

16. The LiDAR sensor as set forth in claim 15, further comprising another diffuser between the optical element and the light emitter.

17. A method of operating a LiDAR sensor, the method comprising:
repeatedly measuring strain measurements in an optical element;
determining that the strain measurements indicate that the optical element is intact;
enabling a light emitter aimed at the optical element to emit light at the optical element in response to the determination that the optical element is intact;
after enabling the light emitter, determining that a subsequent one of the strain measurements indicates that the optical element is damaged; and
disabling the light emitter in response to the subsequent one of the strain measurements.

18. The method as set forth in claim 17, wherein determining that the subsequent one of the strain measurements indicates that the optical element is damaged includes determining that the value of the difference between the subsequent one of the strain measurements and at least one previous strain measurement exceeds a predetermined threshold value.

19. The method as set forth in claim 17, wherein determining that the subsequent one of the strain measurements indicates that the optical element is damaged includes determining that the value of the difference between the subsequent one of the strain measurements and at least one previous strain measurement exceeds a predetermined threshold value over a predetermined period of time.
